(19) United States
(12) Patent Application Publication
(10) Pub. No.: US 2016/0186893 A1
(43) Pub. Date: Jun. 30, 2016

(54) QUICK ATTACHMENT ASSEMBLY FOR WEIGHING OR BEND LIMITER CABLE ASSEMBLIES

(71) Applicant: PMI INDUSTRIES, INC., Cleveland, OH (US)

(72) Inventor: Konstantin Nakovski, Bedford Heights, OH (US)

(73) Assignee: PMI INDUSTRIES, INC., Cleveland, OH (US)

(21) Appl. No.: 14/878,789

(22) Filed: Oct. 8, 2015

Related U.S. Application Data
(60) Provisional application No. 62/061,458, filed on Oct. 8, 2014.

(51) Int. Cl. F16L 1/12

(52) U.S. Cl. CPC F16L 1/123

(57) ABSTRACT

A bend limiter assembly includes at least first and second bodies wherein each body is formed by first and second body portions. The body portions are joined together along a split plane. Each body portion has a semi-circular recess facing the split plane to form a passage through the body upon assembly of the first and second body portions to one another. Each of the first and second body portions has a shoulder spaced axially outward from a first end of the body portion by a reduced dimension neck at the first end to form a male connector member on the body first end when the body portions are assembled. The first and second body portions of each body are assembled about an associated cable received in the passage, and the first and second bodies are assembled in end-to-end fashion such that the male connector member of the first body is received in a female connector member of the second body to allow relative articulation therebetween.

This application claims the priority benefit of U.S. provisional application Ser. No. 62/061,458, filed Oct. 8, 2014, the entire disclosure of which is expressly incorporated herein by reference.

### BACKGROUND

The present disclosure relates to a protective device received over an elongated flexible member such as a cable, and more particularly to either a weighing down of a cable assembly or an articulating or articulating/rotating bend limiter assembly that limits a bending radius of the associated cable and will be described with particular reference thereto. The disclosure may find application in connection with underwater cables, although selected aspects may find use in related environments or applications where common problems are encountered.

Articulated bend limiters are generally known in the art, including commonly owned U.S. Pat. No. 6,039,081 entitled “Articulated Bend Limiter”-Albert, the entire disclosure of which is expressly incorporated herein by reference.

This device is intended for use in an environment that places special demands on the cable. For example, this device may find use in connection with elongated cables that are towed behind a vessel and, may include sensing devices as a part of the towed array. The sensors may be specific to a wide array of uses, for example, underwater seismic exploration is one common use. The loads and dynamic forces imposed on the cable assembly are extensive, and the cable must be adaptable to constantly changing forces.

The articulated bend limiters are used, for example, at terminal ends of the underwater cable. It is desirable that the bend limiter assembly be easily assembled in situ. Being attachable/detachable on-site to the remainder of the underwater cable suspension system is an important attribute. Further, the assembly is preferably adaptable to a wide variety of cable sizes.

Minimizing the number of components is important with regard to manufacture, inventory, and assembly. Simply stated, less components means less equipment required to manufacture the reduced number of components, and also results in less inventory that must be maintained on hand either for original assembly or repair. Simplified assembly is another desired feature. Any improvement that reduces assembly time or ease of assembly is a welcomed modification.

A need exists for an improved articulated bend limiter assembly that satisfies these needs and others in a simple, reliable, effective, and economical manner.

### SUMMARY

A bend limiter assembly includes at least first and second bodies wherein each body is formed by first and second body portions. The body portions are joined together along a split plane.

Each body portion has a semi-circular recess facing the split plane to form a passage through the body upon assembly of the first and second body portions to one another. Each of the first and second body portions has a shoulder spaced axially outward from a first end of the body portion by a reduced dimension neck at the first end to form a male connector member on the body first end when the body portions are assembled.

Each of the first and second body portions has a recess spaced axially inward from a second end of the body portion by a shoulder at the second end to form a female connector member on the body second end when the body portions are assembled.

The first and second body portions of each body are assembled about an associated cable received in the passage, and the first and second bodies are assembled in end-to-end fashion such that the male connector member of the first body is received in a female connector member of the second body to allow relative articulation therebetween.

The male and female connector members of the first and second bodies may each include a circumferentially continuous shoulder at the first end, a circumferentially continuous neck at the first end, a circumferentially continuous shoulder at the second end, and a circumferentially continuous recess at the second end whereby the first and second bodies can rotate relative to one another.

The male and female connector members of the first and second bodies may each include a non-circumferential region on the shoulder at the first end, a non-circumferential region on the neck at the first end, a non-circumferential region on the shoulder at the second end, and a non-circumferential region on the recess at the second end whereby the first and second bodies cannot rotate relative to one another.

The split plane of the first body is non-aligned with the split plane of the second body, for example, at 90 degrees relative to one another.

In an embodiment, the first and second body portions of each body are identical.

In an embodiment, the first and second body portions each include openings that extend in a direction perpendicular to the passage through the body for receiving a detent pin therein.

In an embodiment, the first and second body portions each include openings that extend in a direction parallel to the passage through the body for receiving a detent pin therein.

In an embodiment, each body portion includes a central projection on one side of one of the first and second body portions received between axially spaced end projections on the other side of the other of the first and second body portions.

One benefit is the ability to reduce the number of different components, and thereby reduce inventory, simplify manufacture, and/or simplify assembly.

Another advantage resides in the ability to allow relative articulation between adjacent bodies, and/or relative articulation and rotation between adjacent bodies.

Still another benefit resides in loading the connecting fasteners in shear to increase the strength of the assembly.

Benefits and advantages of the present disclosure will become more apparent from reading and understanding the following detailed description.

### BRIEF DESCRIPTION OF THE DRAWINGS

FIG. 1 shows a cable with a bend limiter assembly of the present disclosure used therewith in linear and bent conformations.

FIGS. 2A-H are various views of a first embodiment of an articulating bend assembly.

FIGS. 3A-E are various views of a second embodiment of a rotating and articulating bend assembly.

### DETAILED DESCRIPTION

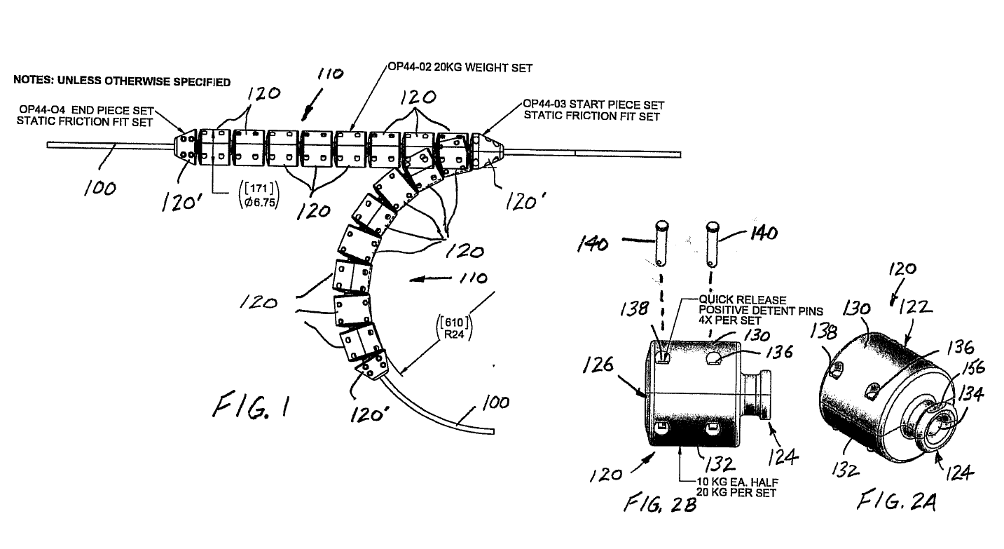

Turning to FIG. 1, there is shown an elongated, flexible member such as a cable 100. The cable 100 is illustrated in a linear/unbent configuration and a non-linear or curved/bent configuration. A bend limiter assembly 110 is received on a portion of the length of the cable 100. More specifically, the bend limiter assembly 110 includes a number of similar/identical bend limiter components 120 that form the assembly when the components are interconnected in end-to-end fashion. Each component 120 is capable of a range or degree of articulation relative to an adjacent component. When all of the components 120 are articulated to the maximum extent relative to adjacent components, further bending of the cable 100 in the region of protection offered by the bend limiter assembly 110 is not possible. This degree of articulation between adjacent components 120 typically results from the components abutting one another to preclude further bending.

When the flexible member is used as a method to add weight to the cable, then the components are not meant to provide bend limiting protection, rather, to allow for articulation of the cable without limiting the bending radius. The radius of bend on the cable will be controlled by winches, fairleads, sheaves, and other components that the cable will travel as it is being deployed or retrieved.

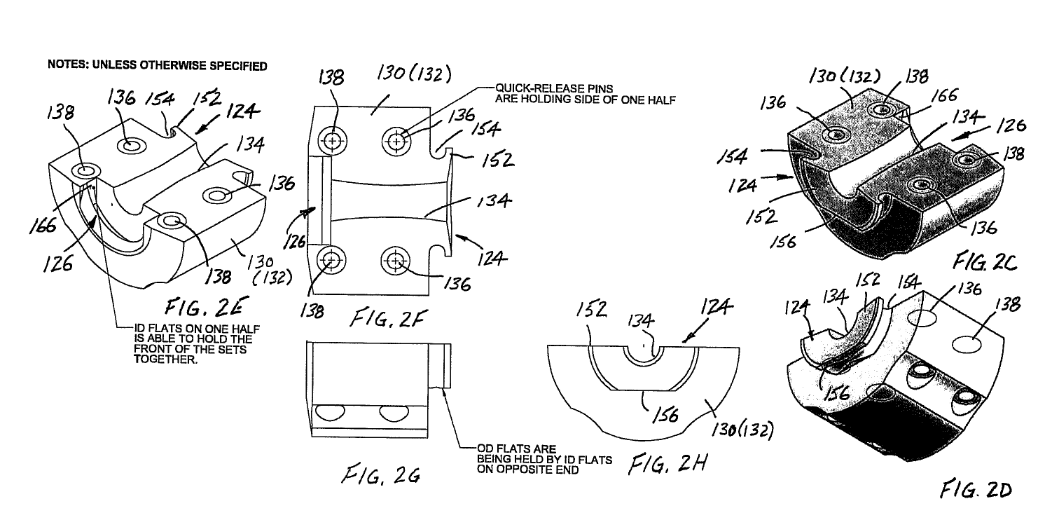

With continued reference to FIG. 1, and additional reference to FIGS. 2A-H, an individual component 120 or portions of a component are illustrated. FIG. 2A is a perspective view of a component 120 that includes a body 122 having a male connector member 124 at a first end and a female connector member 126 at a second end. The component body 122 is shown as having a generally cylindrical conformation, although other external designs or shapes can also be used (for example, end components 120′ have a generally conical shaped, reduced dimension end of the cone preferably located outwardly from a larger dimension end as seen in FIG. 1). The body 122 of the illustrated embodiment includes first and second portions 130, 132 that are preferably the same part. In this manner, the same mold or mold components (not shown) can be used to form first and second body portions 130, 132. The body portions 130, 132 are generally arcuate or C-shaped, and when assembled together with terminal edges of the respective C-shape engaging one another, the body portions form a through opening or passage 134 dimensioned to receive the cable 130 therethrough. Preferably, the first and second body portions 130, 132 have similar structural features to aid in assembly, as well as manufacture. For example, the first body portion 130 has openings 136, 138 that are located for alignment with openings 136, 138 in the second body portion 132. In addition, a quick-release pin 140 is provided for selective receipt through each of the aligned openings 136, 138 in the assembled body portions 130, 132 in order to selectively keep the body portions joined together as shown in FIGS. 2A-2B. Greater details of the body portions 130, 132 are shown in the perspective views of FIGS. 2C-2E, as well as the plan view of FIG. 2F, the bottom view of FIG. 2G, and the end or elevational view of FIG. 2H.

Since each body portion 130, 132 is identical to the other, description of one body portion is fully applicable to the other body portion unless specifically noted otherwise. Thus as illustrated in FIGS. 2C-2H, a body portion 130 (132) includes one half of the male connector member 124 so that when disposed in a mating arrangement with the other body portion, the male connector member 124 is formed. Each half of the male connector member 124 includes an enlarged shoulder 152 adjacent a reduced dimension neck or recess 154. The shoulder 152 is axially spaced from the remainder of the body portion 130 (132) by the neck 154. In addition, in the embodiment of FIGS. 2A-2H, the male connector member 124 includes first outer flats or planar regions 156 along outer diameter portions of the male connector member. The outer flats 156 are configured for operative mating engagement with second flats or planar regions 166 at the opposite end or within the female recess portion 126 of an adjacent component 120 (132). The outer flats 156 on the male connector member 124 are also advantageously oriented 90 degrees relative to inner flats 166 on the female recess portion 126. In this manner, when the male connector member 124 of one component 120 is received in the female recess portion 126 of the next adjacent component (by assembling the body portions 130, 132 of each component 120 together), the parting or dividing face of one adjacent component is oriented 90 degrees relative to the next adjacent component (see FIG. 1 where the parting line formed between the body portions 130, 132 is visible on every other component 120). The mating engagement of the outer and inner flats 156, 166, respectively, prevent rotation of one component 120 relative to the next adjacent component, although the conformation of the male connector member and the adjacent female recess allows a preselected amount of articulation or bending of adjacent components in this embodiment.

It is also noted that opening 134 through the assembled body is contoured or tapered at opposite ends to allow some range of flexing of the cable 100 relative to the component 120 that holds the cable therein. This is perhaps best illustrated in FIG. 2F.

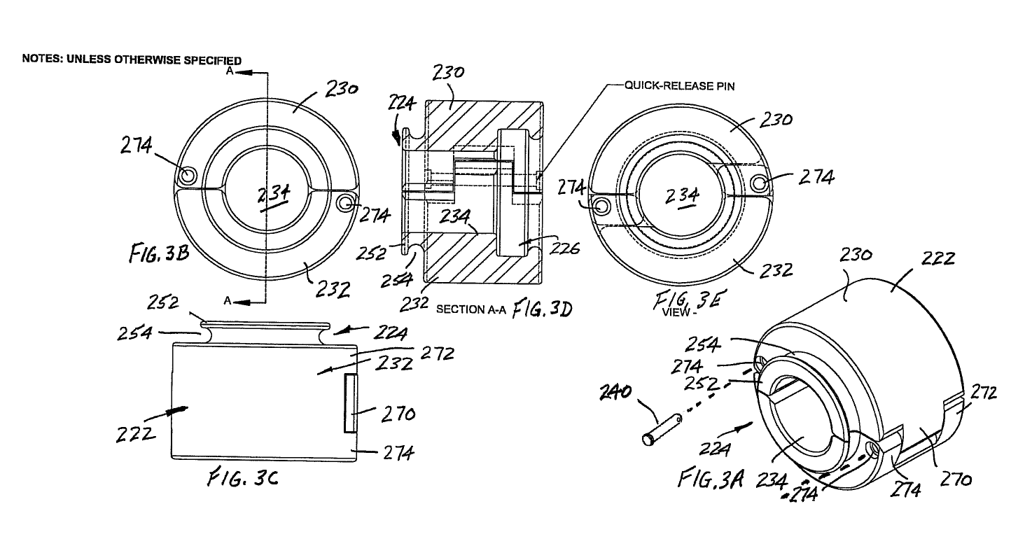

The second embodiment of FIGS. 3A-E has many similarities to the embodiment FIGS. 2A-H. Where possible, like features are identified by like reference numerals increased by “100”. For example, the body 122 of FIG. 2 is now referenced as body 222 of FIG. 3. A primary distinction is that the embodiment of FIGS. 3A-E is capable of articulation like the earlier described embodiment, but is also capable of rotation of one component 220 relative to an adjacent component. More specifically, the flats 156 used in the embodiment of FIGS. 2A-H are eliminated in this embodiment of FIGS. 3A-E. Instead, male connector member 224 preferably forms a complete circumference or circle, and the female recess portion 226 likewise extends over a complete circumference. In addition, the body portions 230, 232, that together form a complete body 222 of component 220, are similar but not identical. The body portions 230, 232 each have a central projection 270 on one side and a pair of axially spaced end projections 272 on the other side (FIG. 3A). Thus, the central projection 270 of one body portion 230 (232) is received between the end projections 272 of the other body portion 232 (230). In addition, openings 274 extend through each of the central projections 270 and end projections 272, and are sized to receive the quick-release pin 240—one on each side of a component. The openings 274 in the projections 270, 272 extend in an axial direction in a direction between the male and female ends of the assembly, and thus the openings are substantially parallel with the through opening 234 formed centrally through the body 222.

The method/arrangement of holding the two halves together in FIG. 3 differs from the method/arrangement in FIG. 2. The load applied on the quick release (q-r) pin in FIG. 2 is axial and the load is applied on the detent feature of the quick release pin. In FIG. 3, on the other hand, the pin is loaded in shear so no load is applied on the detent of the quick release pin. In known assemblies, the bend limiters are secured together with screws or clamps, resulting in a much more difficult arrangement that requires tools for assembly/disassembly as opposed to a set of four quick release positive detent pins received in opening 136, 138 in the embodiment of FIG. 2 or in in openings 274 in the embodiment of FIG. 3. As a result, the pins are easily and quickly installed and can hold a large amount of load.

In both arrangements, the loads imposed on the quick release pins are shear forces or shear loads, i.e., across the diameter of the elongated pins, when the body portions of an assembled body try to separate from one another along the split plane dividing the body portions. Generally, the pins are stronger in shear and increased the load that the assembly can handle.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

It is claimed:

1. A bend limiter assembly comprising:
at least first and second bodies wherein each body is formed by first and second body portions joined together along a split plane, each body portion having a semi-circular recess facing the split plane to form a passage through the body upon assembly of the first and second body portions to one another, and each having a shoulder spaced axially outward from a first end of the body portion by a reduced dimension neck at the first end to form a male connector member on the body first end when the body portions are assembled, and each having a recess spaced axially inward from a second end of the body portion by a shoulder at the second end to form a female connector member on the body second end when the body portions are assembled, the first and second body portions of each body assembled about an associated cable received in the passage, and the first and second bodies assembled in end-to-end fashion such that the male connector member of the first body is received in a female connector member of the second body to allow relative articulation therebetween.

2. The bend limiter assembly of claim 1 wherein the male and female connector members of the first and second bodies each have a circumferentially continuous shoulder at the first end, a circumferentially continuous neck at the first end, a circumferentially continuous shoulder at the second end, and a circumferentially continuous recess at the second end whereby the first and second bodies can rotate relative to one another.

3. The bend limiter assembly of claim 1 wherein the male and female connector members of the first and second bodies each have a non-circumferential region on the shoulder at the first end, a non-circumferential region on the neck at the first end, a non-circumferential region on the shoulder at the second end, and a non-circumferential region on the recess at the second end whereby the first and second bodies cannot rotate relative to one another.

4. The bend limiter assembly of claim 3 wherein the split plane of the first body is non-aligned with the split plane of the second body.

5. The bend limiter assembly of claim 4 wherein the split plane of the first body is oriented 90 degrees relative to the split plane of the second body.

6. The bend limiter assembly of claim 1 wherein the split plane of the first body is non-aligned with the split plane of the second body.

7. The bend limiter assembly of claim 6 wherein the split plane of the first body is oriented 90 degrees relative to the split plane of the second body.

8. The bend limiter assembly of claim 1 wherein the first and second body portions of each body are identical.

9. The bend limiter assembly of claim 1 wherein the first and second body portions each include openings that extend in a direction perpendicular to the passage through the body for receiving a detent pin therein.

10. The bend limiter assembly of claim 1 wherein the first and second body portions each include openings that extend in a direction parallel to the passage through the body for receiving a detent pin therein.

11. The bend limiter assembly of claim 10 wherein each body portion includes a central projection on one side of one of the first and second body portions received between axially spaced end projections on the other side of the other of the first and second body portions.
